(19) United States
(12) Patent Application Publication
(10) Pub. No.: US 2011/0068052 A1
(43) Pub. Date: Mar. 24, 2011

(54) Slot sieve and holding device for the production thereof

(76) Inventor: Thorsten Zöllner, Neumarkt /OPf. (DE)

(21) Appl. No.: 12/887,749

(22) Filed: Sep. 22, 2010

(30) Foreign Application Priority Data
Sep. 23, 2009 (DE) 10 2009 042 357.5

(51) Int. Cl. B07B 1/12; B07B 1/46

(52) U.S. Cl. 209/394; 209/393

(57) ABSTRACT

A slot sieve comprises a large number of sieve profiles arranged next to one another, which form a respective sieve slot between their longitudinal sides, and at least two, preferably a plurality of carrier profiles, which extend transverse to the sieve profiles and on which the sieve profiles are fastened. The carrier profiles are arranged in receiving grooves, which respectively align with one another, in the sieve profiles in such a way that the outsides of the carrier profiles remote from the sieve profiles are located in a plane with the slot sides or lower sides remote therefrom of the sieve profiles.

### FIELD OF THE INVENTION

The invention relates to a slot sieve comprising a plurality of sieve profiles arranged next to one another, which in each case form a sieve slot between their longitudinal sides, and at least two, preferably a plurality of carrier profiles, which extend transverse to the sieve profiles and on which the sieve profiles are fastened, and a holding device for the production thereof.

### BACKGROUND OF THE INVENTION

A slot sieve of this type is known through public prior use and generally has a plurality of sieve profiles arranged next to one another, which in each case form a sieve slot between their longitudinal sides. The sieve profiles are trapezoidal in cross section, in this case, the actual sieve slot being configured between the wide base sides.

The individual sieve profiles are connected to one another by carrier profiles which extend transverse thereto, on which the sieve profiles are fastened with their narrow sides, such as are formed by the trapezoidal cross section. These transversely extending carrier profiles are generally welded under the profile bars.

Furthermore, so-called loop slot sieves are known, in which the individual sieve profiles are looped at certain intervals to form a loop. Round carrier profiles are then inserted in the loops which align with one another of sieve profiles located next to one another. These round cross bars can be riveted at their ends without further reinforcement. Furthermore it is possible to screw the cross bars and weld them. Finally, loop slot sieves of this type can be provided at their sides extending parallel to the slot profiles with an edge rail for reinforcement, which is screwed and welded to the cross bars.

The internet page with the URL address

“http://www.heinlehmann.de/cgi-bin/cmsshow.exe?mode=start&u_{—}3xz=&p_{—}3xz=&gowd=&B_ID=10&R_ID=61&UR_ID=219&start=urubrik”

can be given as the site for finding public prior uses of this type, for example.

The problem in the two variants mentioned above of previously known slot sieves is the fact that the transversely extending carrier profiles extend outside the area plane spanned by the sieve profiles. As slot sieves of this type are now often used in a configuration curved about an axis, as so-called sieve troughs, the difficulty is produced from the presence of the described carrier profiles that sieves of this type can only be curved around an axis extending transverse to the carrier profiles. A bend about axes of curvature extending parallel to the longitudinal axes of the carrier profiles is practically not possible as the conventionally used bending roller pairs do not find any uniform thickness of the slot sieves in the rolling direction because of the projecting carrier profiles.

A further drawback in the known slot sieve is that the slot widths generally change when a sieve is bent as the carrier profiles are spaced apart from the actual sieve plane of the slot sieve spanned by the sieve slots.

### SUMMARY OF THE INVENTION

Proceeding from the problems of the prior art described, the invention is based on the object of improving a slot sieve of the generic type in such a way that problem-free bending is made possible with constant slot widths.

This object is achieved by a slot sieve in which the carrier profiles are arranged in receiving grooves, which respectively align with one another, in the sieve profiles in such a way that the outsides of the carrier profiles opposite to the sieve profiles are located in a plane with the slot sides or lower sides opposite therefrom of the sieve profiles, according to which the carrier profiles are arranged in receiving grooves respectively aligning with one another in the sieve profiles in such a way that the outsides of the carrier profiles remote from the sieve profiles are located in a plane with the slot sides or lower sides remote therefrom of the sieve profiles.

Because of this positioning of the carrier profiles, these are located within the enveloping plane spanned by the slot sides or lower sides remote therefrom of the sieve profiles, so the slot sieves have level outline faces on their two flat sides. Bending tools in the form of roller pairs can thus engage thereon without problems and shape the slot sieves accordingly about axes of curvature oriented virtually in any desired manner into a trough-shaped configuration. A further advantage of the slot sieves according to the invention is the fact that the ratio of the open area to the total area of the sieve can be significantly improved compared to conventional slot-milled slot sieves. An increase from, for example, 9% to 17% open area fraction is typical.

The sieve profiles in the region of their slot sides are fixed by the carrier profiles, in which the outsides of the carrier profiles are arranged flush with the slot sides of the sieve profiles, so that, independently of an incorporated curvature, the sieve slots retain an exact preassembled width.

Owing to the preferred embodiment, in which the sieve profiles have a respective trapezoidal cross section, at least in their profile region facing the sieve slot, their wide base sides forming the slot side of the respective sieve profile, the sieve profiles have a wide base, which can be connected in a particularly stable manner to the carrier profiles let into these sides. This benefits the robustness of the sieves according to the invention.

The development of the slot sieves, in which the carrier profiles are in each case flat-rectangular or triangular in cross section, one of their wide sides forming the outside of the respective carrier profile, serves the same purpose.

A minimum width of the sieve slots of in each case about 1 μm and a maximum width of the sieve slots of in each case about 10 mm characterise a preferred slot width range for the sieve slots.

A configuration of the sieve and carrier profiles in each case as wire profiles made of metal and a connection of the sieve and carrier profiles to one another by roller welding, on the one hand, as well as a configuration of the sieve and carrier profiles in each case as plastics material profiles and a connection of the sieve and carrier profiles to one another by ultrasonic welding, on the other hand, relate to the different configuration of the sieve and carrier profiles as wire profiles made of metal or as plastics material profiles. The corresponding selection is made with regard to the purpose of use of the respective sieve, it being possible to carry out the connection of the profile elements in a particularly efficient manner with a roller welding when using metallic wire profiles.

In the alternative use of plastics materials for sieve and carrier profiles, the slot sieves produced thereby are light and corrosion-resistant. Furthermore, an ultrasonic welding of the profile elements can be used here as a particularly elegant joining technique. Examples of possible plastics materials are PA, PE, PP, PPS and ABS.

An arrangement of narrower lamellar intermediate webs, which are held by the carrier profiles and form a sieve slot with the respective adjacent sieve profile, between the sieve profiles, and a configuration of the intermediate webs as flat metal sheets, the narrow longitudinal sides of which are located in a plane with the slot sides of the sieve profiles, characterise preferred developments, in which narrower, lamellar intermediate webs are arranged between the sieve profiles. These are preferably configured as flat metal sheets, the narrow longitudinal sides of which are located in a plane with the slot sides of the sieve profiles. The ratio of the open area of the sieve to the total area can be again improved with the aid of these intermediate webs. The reason for this is that the narrow longitudinal sides of the intermediate webs are significantly narrower than the base sides of the sieve profiles, so that merely owing to the small area requirement of the web narrow sides, a doubling of the sieve slot and therefore of the open area of the sieve can be achieved.

The invention also relates to a holding device, having receivers, that are defined with respect to their spacing, for a respective sieve profile for adjusting a desired width of the sieve slot, such as can be used to manufacture the slot sieve(s) according to the invention. Slot sieves with particularly small slot widths, which have exacting tolerances, down to 1 μm can thus be produced.

Further features, details and advantages of the invention emerge from the following description of an embodiment with the aid of the accompanying drawings.

### BRIEF DESCRIPTION OF THE DRAWINGS

FIG. 1 shows a perspective view of a slot sieve,

FIG. 2 shows a view from the arrow direction II according to FIG. 1,

FIG. 3 shows a perspective detail enlargement of the detail A according to FIG. 1,

FIG. 4 shows a schematic cross section through a holding device for use in the manufacture of a slot sieve,

FIGS. 5 and 6 each show a perspective partial enlargement analogous to FIG. 3 in two further embodiments of a slot sieve, and

FIG. 7 shows a perspective detail-wise view of a slot sieve in a further embodiment.

### DESCRIPTION OF THE PREFERRED EMBODIMENT

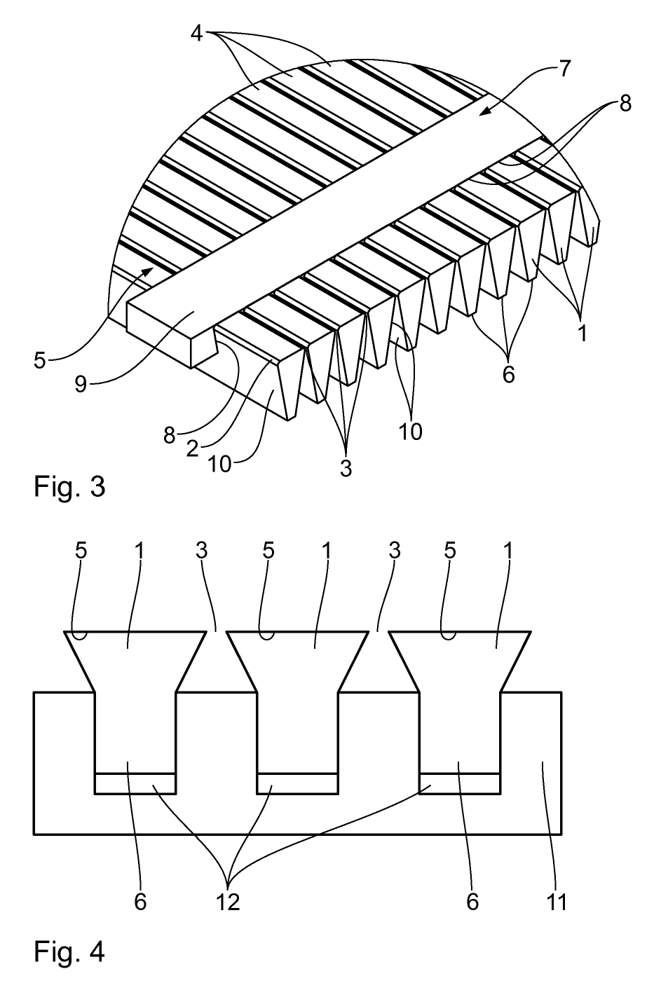

As becomes clear from the drawings, a slot sieve has a large number of sieve profiles 1 arranged in parallel next to one another, the longitudinal sides 2 of two adjacent sieve profiles 1 forming a sieve slot 3 in each case. As FIG. 3, in particular, makes clear, the individual sieve profiles 1 are trapezoidal in cross section, the wide base sides 4 being arranged in a common plane and forming the slot side 5 of the respective sieve profile 1 or the slot sieve itself.

The narrow sides 6 of the sieve profiles 1 form the lower side of the sieve.

The sieve profiles 1 are held together by carrier profiles 7 extending transverse to them, which are in each case arranged in receiving grooves 8 that align with one another in the base sides 4 of the sieve profiles 1. The contour of these receiving grooves 8 corresponds to the flat-rectangular cross section of the carrier profiles 1, so these are let into the sieve profiles 1 and rest with their outsides 9 remote from the sieve profiles 1 in a plane with the slot side 5 of the sieve profiles 1. Three carrier profiles 7 of this type are arranged parallel with one another distributed over the width of the sieve.

The mutually facing flanks 10 of the sieve profiles 1 form a widening discharge channel for the liquid to be cleaned.

The dimension of the sieve slots 3, depending on the filter task, is, for example, between a minimum width of about 1 μm to a maximum width of about 10 mm.

The materials of the sieve and carrier profiles 1, 7 are, for example, suitable plastics materials, it then possible to connect the profiles by ultrasonic welding.

A conventional configuration of the sieve and carrier profiles 1, 7 as wire profiles made of metal is also conceivable. A roller welding is then recommended for efficient connection of the sieve components.

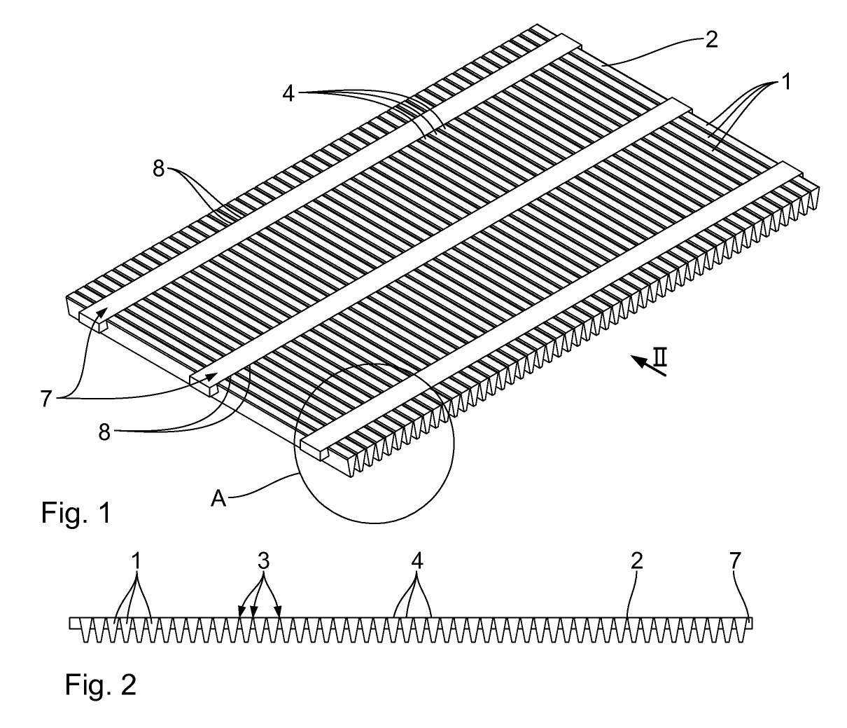

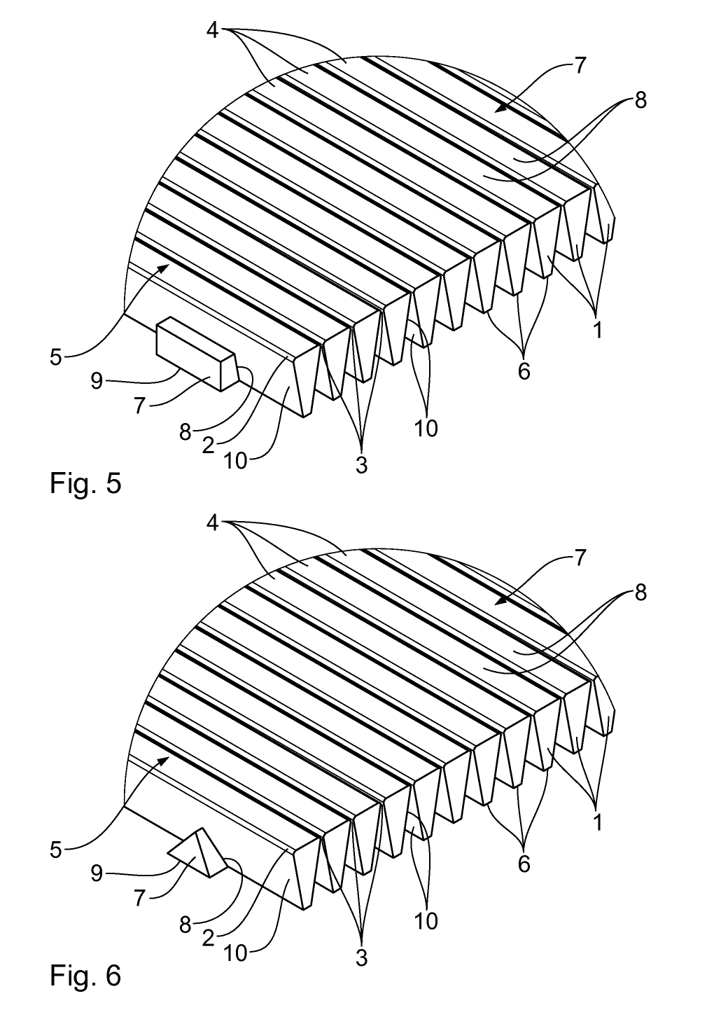

FIG. 4 shows a schematic section through a holding device 11, as can be used when manufacturing a slot sieve according to FIG. 1 to 3. The sieve profiles 1 have a trapezoidal cross section only in their region facing the sieve slot 3 and the profile shape then passes into a rectangular profile. The holding device 11 itself has corresponding receivers 12 for the individual sieve profiles 1, which are inserted with their rectangular cross sectional part into the receivers 12. The sieve profiles 1 can thus be positioned very precisely, so the sieve slots 3 can also be manufactured very narrow and with exact tolerances in relation to the width variation of the sieve slot 3 over its length.

In the embodiment shown in FIG. 5 of a slot sieve, the carrier profiles 7 which are flat-rectangular in cross section analogously to the embodiment according to FIG. 1, are not arranged on the slot side 5 of the sieve profiles 1, but arranged in the lower sides 6 remote therefrom in turn in corresponding receiving grooves 8. The outside 9 of the carrier profiles 7 is again located here in a plane aligned with the narrow lower side 6 of the sieve profiles 1.

In the embodiment shown in FIG. 6, the carrier profiles 7 are arranged accordingly on the lower side 6 of the sieve profiles 1 and their cross sectional shape is not flat-rectangular, however, but triangular. Accordingly, the cross sectional shape of the receiving grooves 8 milled into the lower side 6 of the sieve profiles 1 is triangular. The base side forming the outside 9 of the carrier profile 7 is also arranged here in a plane aligned with the narrow lower sides 6 of the sieve profiles.

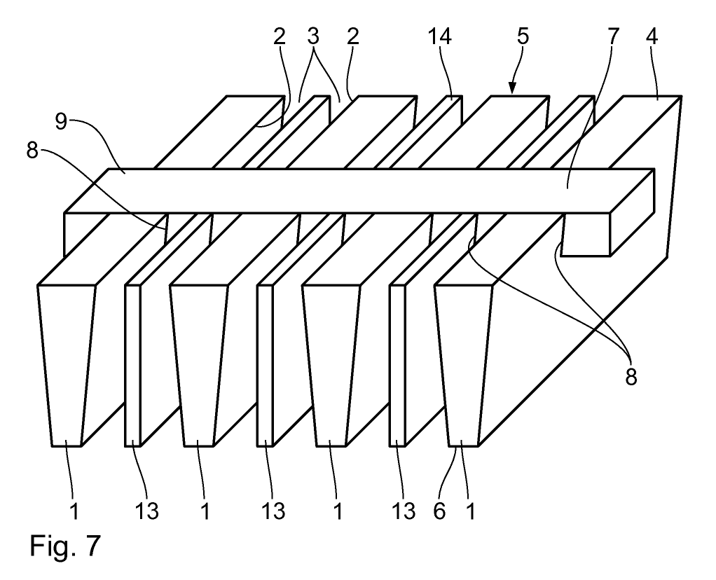

The embodiment shown in FIG. 7 of a slot sieve, with regard to its basic configuration, corresponds to the sieve shown in FIG. 1 with cross sectionally trapezoidal sieve profiles 1, flat-rectangular carrier profiles 7 to hold the sieve profiles 1 in turn being inserted on the slot side 5 thereof in corresponding receiving grooves 8. Inserted between two adjacent sieve profiles 1 in this embodiment are, however, also intermediate webs 13, the main plane of which extends transverse to the sieve surface and the narrow longitudinal sides 14 of which are located in a plane with the slot sides 5 of the sieve profiles 1. These lamellar intermediate webs 13 are also held by the carrier profiles 7, which extend in corresponding receiving grooves 8 in the intermediate webs 13. Two sieve slots 3 are in each case formed by the insertion of the intermediate webs 13 with respect to the two adjacent sieve profiles 1.

What is claimed is:

1. A slot sieve comprising
a plurality of sieve profiles (1) arranged next to one another, which in each case form a sieve slot (3) between their longitudinal sides and have slot sides and lower sides (5, 6), and
at least two, preferably a plurality of carrier profiles (7), which extend transverse to the sieve profiles (1) and on which the sieve profiles (1) are fastened, wherein the carrier profiles (7) are arranged in receiving grooves (8), which respectively align with one another, in the sieve profiles (1) in such a way that outsides (9) of the carrier profiles (7) opposite to the sieve profiles (1) are located in a plane with the slot sides or lower sides (5, 6) opposite therefrom of the sieve profiles (1).

2. A slot sieve according to claim 1, wherein the outsides (9) of the carrier profiles (7) are arranged flush with the slot sides (5) of the sieve profiles (1).

3. A slot sieve according to claim 1, wherein the sieve profiles (1) have a respective trapezoidal cross section, at least in their profile region facing the sieve slots (3), their wide base sides (4) forming the slot side (5) of the respective sieve profile (1).

4. A slot sieve according to claim 1, wherein the carrier profiles (7) are in each case flat-rectangular or triangular in cross section, one of their wide sides forming the outside (9) of the respective carrier profile (7).

5. A slot sieve according to claim 1, wherein a minimum width of the sieve slots (3) is in each case about 1 μm.

6. A slot sieve according to claim 1, wherein a maximum width of the sieve slots (3) is in each case about 10 mm.

7. A slot sieve according to claim 1, wherein the sieve and carrier profiles (1, 7) are in each case configured as wire profiles made of metal.

8. A slot sieve according to claim 7, wherein the sieve and carrier profiles (1, 7) are connected to one another by roller welding.

9. A slot sieve according to claim 1, wherein the sieve and carrier profiles (1, 7) are in each case configured as plastics material profiles.

10. A slot sieve according to claim 9, wherein the sieve and carrier profiles (1, 7) are connected to one another by ultrasonic welding.

11. A slot sieve according to claim 1, wherein narrower lamellar intermediate webs (13), which are held by the carrier profiles (7) and form a sieve slot (3) with the respective adjacent sieve profile (1), are arranged between the sieve profiles (1).

12. A slot sieve according to claim 11, wherein the intermediate webs (13) are configured as flat metal sheets, the narrow longitudinal sides (14) of which are located in a plane with the slot sides (5) of the sieve profiles (1).

13. A holding device for producing a slot sieve has a plurality of sieve profiles (1) arranged next to one another, which in each case form a sieve slot (3) between their longitudinal sides, and at least two, preferably a plurality of carrier profiles (7), which extend transverse to the sieve profiles (1) and on which the sieve profiles (1) are fastened, the holding device (11) comprising receivers (12), that are defined with respect to their spacing, for a respective sieve profile (3) for adjusting a desired width of the sieve slot (3).
